(19) United States
(12) Patent Application Publication
(10) Pub. No.: US 2007/0159324 A1
(43) Pub. Date: Jul. 12, 2007

(54) Guardian

(76) Inventor: Payman Ahmadinia, Long Beach, CA (US)

Correspondence Address: Payman Ahmadinia, 14111 S. Main Street, #A, Los Angeles, CA, 90061, US

(21) Appl. No.: 11/463,274

(22) Filed: Aug. 8, 2006

Related U.S. Application Data
(60) Provisional application No. 60/706,659, filed on Aug. 10, 2005.

(51) Int. Cl. G08B 1/08

(52) U.S. Cl. 340/539.21; 340/539.23

(57) ABSTRACT

A loss prevention product (“The Guardian”) consisting of 1 receiver/pager unit and multiple low powered transmitter units, which the consumer will affix to any personal item he/she chooses to protect. The receiver/pager will then alert the consumer if any of his/her personal items equipped with the transmitters are about to be left behind or separated from him/her. Audible alarm or vibrations alert the consumer once any item equipped with a transmitter is beyond the distance range of the receiver/pager. The receiver/pager can also alert the consumer as to which particular transmitter is out of range using any of the assignable item descriptions available on the receiver/pager (ie: “Wallet”, “Cell Phone”, PDA”, etc . . .). The receiver/pager will also alert the consumer as to when the batteries on the transmitters or the receiver/pager itself need to be changed.

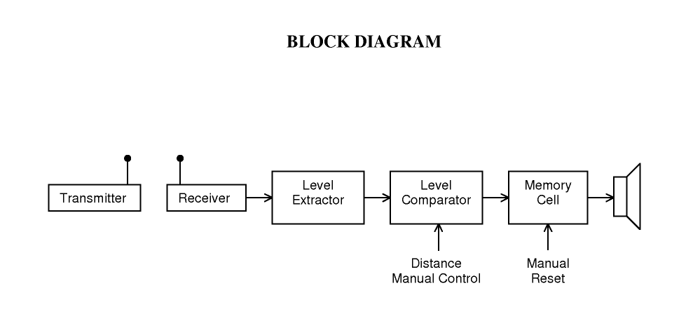

### CROSS REFERENCE TO RELATED APPLICATIONS

Provisional patent for the same present invention filed on Aug. 10, 2005 by same applicant,
APPL NO. 60/706,659
Confirmation No. 2959

### FEDERALLY SPONSORED RESEARCH

Not Applicable

### DESCRIPTION OF ATTACHED APPENDIX

Not Applicable

### FIELD OF INVENTION

The invention relates to the loss prevention of personal everyday items usually carried around by the consumer, particularly, to electronics, valuables, and keys.

### BACKGROUND OF THE INVENTION

In the prior art one such loss prevention product (commonly knows as a “locator”) was used to try to locate an already lost item such as a key chain. This was done using a receiver, which would recognize either a consumer produced sound (like a clap or whistle) or an electronic signal from a secondary provided component. Once the receiver recognized the sound or signal it would sound an alarm, which the consumer would follow to locate the lost item.

One significant problem with the above process is if the receiver on the lost item is out of range to recognize the sound or signal, it will fail to respond with an alarm for the consumer to follow and locate the lost item. This also means that any such “locator” would be used only in smaller proximities where an item is likely to have been misplaced (meaning the consumer knows the item is in the room, for example, but not sure exactly where). Of course, this renders any such “locator” useless if an item is left behind and later noticed missing or lost.

In the prior art another such loss prevention product used radio transmitters, which would be tracked by a public or private agency (such as a local police or alarm company) once the consumer reported a theft of the protected item. This service has been exclusive to the protection of automobiles until very recent when companies like “Lojack” have also offered the service for smaller personal items such as laptops.

The more advanced and also more expensive process using a transmitter and a tracking service shares the same problem as the “locator” device in which the consumer can use the product only after he/she notices an item missing or stolen. Also, cost and size factors would not render a tracked transmitter type device feasible for most personal items such as I-Pods, wallets, cell phones, PDAs, etc . . .

### SUMMARY OF THE INVENTION

By the present invention, an improved and true loss prevention device is disclosed.

Accordingly, the present invention is the next and more practical step towards the protection of personal items, which seem to be growing in quantities, significance, and value among everyday consumers. Unlike previous products/services meant to be used only after an item is lost or stolen, the present invention is a true loss prevention product, which will alert consumers as soon as a protected personal item is being left behind or taken away from them. Therefore, the present invention is the first product which will help prevent loss of personal items in the first place.

The present invention (“The Guardian”) comes with a pager type receiver carried by the consumer. Also provided are low powered transmitters, which the consumer adheres/affixes to any personal item of value which is normally carried around by the consumer.

The provided transmitters each have a specific operational frequency individually recognized by the receiver. Once any of the transmitters is out of the consumer set range of distance from the receiver, the receiver (pager) will alert the consumer of the separation, also noting which of the provided transmitters has triggered the alert. This will be of particular use if each transmitter is assigned one of the many preset item descriptions available on the receiver/pager such as “Wallet”, “PDA”, “Cell Phone”, “Lap Top”, etc . . . allowing the consumer to quickly identify and collect the personal item which is about to be left behind or separated from him/her.

The receiver/pager can be switched to a silent mode so a vibration instead of an audible alarm alerts the consumer. The receiver/pager can also be turned off or disabled when consumer does not need to be alerted.

Additionally, the receiver/pager will alert the consumer when the transmitters or the receiver itself will need new batteries for proper operation.

### BRIEF DESCRIPTION OF THE BLOCK DIAGRAM

The block diagram depicts all currently available components and their sequence necessary to produce the present invention.

What is claimed is:

1. A true loss prevention product (“The Guardian”) designed for valuable personal items comprising:
A provided receiver/pager device carried by consumer
Provided low powered transmitters to be affixed to any item usually carried around by consumer.

2. The loss prevention product (“The Guardian”) in claim 1 wherein said transmitters each operate on a specific and uniquely identifiable frequency.

3. The transmitters in claim 1 where said transmitters are ready to affix to any personal item using either the adhesive backing or small holes which can be used to either sew said transmitter to a feasible material or to hook said transmitter to the personal item such as a key chain or a loop type component of any personal item.

4. The small holes in claim 3 wherein said holes have a spring loaded and lockable mechanism allowing said transmitters to securely hook onto an available loop.

5. The loss prevention product (“The Guardian”) in claim 1 wherein said receiver/pager recognizes the frequency specific signal of each said individual transmitter.

6. The loss prevention product (“The Guardian”) in claim 1 wherein said receiver/pager will alert the consumer once any of the said transmitters are out of the range of distance from said receiver/pager.

7. The receiver/pager in claim 1 wherein the said out of range transmitter(s) is/are identified to the consumer using the many preset and assignable descriptions available on the said receiver/pager or by pre-assigned numbers if no description is assigned to said transmitter(s).

8. The receiver/pager in claim 1 wherein said receiver/pager will alert consumer when either the transmitters or the receiver/pager itself needs new batteries.
